(19) United States
(12) Patent Application Publication
(10) Pub. No.: US 2013/0124530 A1
(43) Pub. Date: May 16, 2013

(54) Blood-Type Matching System

(71) Applicant: Mike Dammann, Hamburg (DE)

(72) Inventor: Mike Dammann, Hamburg (DE)

(21) Appl. No.: 13/679,983

(22) Filed: Nov. 16, 2012

Related U.S. Application Data
(60) Provisional application No. 61/560,352, filed on Nov. 16, 2011.

(51) Int. Cl. G06F 17/30

(52) U.S. Cl. CPC G06F 17/30598
USPC 707/740

(57) ABSTRACT

An interactive website, preferably hosted on a secured server, fashioned to simplify and expedite the dating process by matching individuals to other individuals of the opposite sex based primarily on the compatibility of the individuals' blood-types. With respect to the online service of the present invention, blood-type matches are suggested based on the compatibility of a hypothetical blood donation flowing from male to female. Knowledge of one's blood-type is required to become a user. Other characteristics may be implemented to help narrow search results, which may be edited on a user's profile page, distinguishing individuals by preferences, qualities, and appearance.

This is a non-provisional application of provisional patent application No. 61/560,352 filed on Nov. 16, 2011, and priority is claimed thereto.

### FIELD OF THE PRESENT INVENTION

The present invention relates to a dating or mate matching service configured to match individuals together based on the compatibility of their blood types as though the male was the donating party and the female was the receiving party of the hypothetical blood transfer. The system is internet-based, and provides services via a secured server computer hosting content and comparisons of individuals to the internet. It is the intent of the present invention to appropriately match individuals to each other based on the inherent compatibility of their individual blood types, based on the theory that couples with compatible blood types are more likely to have healthier offspring and more fruitful relationships than couples with incompatible blood-types.

### BACKGROUND OF THE PRESENT INVENTION

In the modern age of computers and meals on-the-go, people have seemingly even less time on their hands to devote to dating. Often people work 8 to 10 hours a day, returning home exhausted, only to rise and repeat the routine over again the next day, leaving little time for serious dating. Many services have been crafted to combat this time constraining issue, including everything from speed dating meetings at physical locations in town, or compatibility matching websites, such as Match.com™ or E-harmony.com™ designed to expedite and increase the efficacy of the dating process. These sites function as expected, conventionally matching individuals based on similar interests and personality comparisons, and allowing the user to dynamically set custom criteria pertaining to what characteristics the individual is ideally searching for in a mate, such as age, physical characteristics, and other common traits. While the intention of these services isn't to replace dating altogether, they are designed to facilitate meeting people with a higher propensity of exhibiting the characteristics of an ideal mate.

However, many characteristics are left out of these dating services which could also be useful in the search for the best pool of potential mates. Genetic traits, such as a higher propensity for disease or an increased risk of stroke, blood-type, or simply the recessive trait of red hair could be of interest to certain individuals. Of the omitted traits, blood-type may be one of the most pertinent and relevant qualities of an individual, as recent studies have shown a correlation between potential birth-defects and mismatched blood-types in couples. Evidence has shown that, if the two parents of a child do not possess blood-types compatible with one another, then the resulting alleles constituting the child's blood could be in conflict with those of the mother, potentially contributing to birth defects, birth complications, miscarriages, abnormal growth, and/or a shorter lifespan. It is only with recent technology and medications that doctors have been able to save the lives of babies in utero to combat this act of the human body, in the mother's womb, to attempt to reject the baby prior to birth, given that the mother's blood is incompatible with the baby's.

The primary means by which a couple can avoid these scenarios is by verifying that their blood-types are compatible prior to bearing children. Unfortunately, this is often not prevalent in the minds of many couples. In fact, many individuals are not even aware of their own blood-type, let alone their partner's. If there were a way to present individual's blood-types in advance, prior to engaging in the courtship or dating process, such instances of couples bearing a child with a conflicting blood-type from that of the mother would be likely be less common.

Thus, there is a need for a method and system by which individuals may meet each other with the foreknowledge of each other's blood-types, helping to ensure that if the couple were to foster a relationship, that their offspring would have the least likelihood of pregnancy complications.

### SUMMARY OF THE PRESENT INVENTION

The present invention is a blood-type date matching service presented on a website, hosted by a secured server computer, and configured to connect individuals together based on common blood-type alleles. The preferred embodiment of the present invention exists as an interactive social website, crafted to match individuals to a pool of other individuals maintaining a blood-type compatible with the suitor for transferring or donating blood. Individuals are categorized on the website according to their blood-type, be it A, B, AB, or O, and all the positive and negative accentuations of each. Individuals wishing to be matched to other individuals based on blood-type compatibility preferably must first create a user profile on the website. The profile must indicate what the individual's blood-type is, which must be submitted to the site upon profile creation. In the event that an individual does not know his or her blood-type, the website of the present invention is configured to supply blood testing kits to these individuals for a nominal fee. The conventional testing kits are designed to be easy to use without additional assistance, and to collect blood into a vial or other small container with relative ease. The blood may then be mailed securely and sanitarily in a preferably prepaid and pre-addressed envelope to a blood testing center in order to determine the individual's blood-type. After the individual's blood-type has been confirmed, the individual's profile is now complete, and he or she may begin to use the service and website of the present invention.

Individuals are matched as though the male was giving the female a blood donation; however ideal candidates will be able to share blood between each other regardless of gender. Therefore, preference will be granted to those individuals with an identical blood type to the user, who will be listed as ‘top matches’ upon executing a search for matches from the pool of users of the present invention. If the user performing the search is male, then in the event that the user is not presented with an appealing prospect within the list of ‘top matches,’ the user will preferably be presented with a list of ‘good matches,’ which includes all female individuals with a blood-type who maintain the capacity to receive a blood donation from the user. These matching users must then share one of two alleles composing his blood-type. If the user performing the search is female, the list of ‘good matches’ will only include individuals who may donate blood to her without complications.

For example, if ‘individual A’ is a male with a blood-type of B+, then upon registering for the service of the present invention, ‘individual A’ will first be presented with a list of ‘ideal’ matches, namely exclusively females with a blood-type of B+ as well. These individuals matching the blood-type of B+ will preferably be displayed in a list form, with photos accompanying each profile match, and potentially maintain numerous pages of individuals; therefore, other qualities and characteristics may be added to help facilitate effective searches to narrow the result set. This is preferably accomplished via conventional tagging protocols, which associate cultural preferences, conventionally known on most social network services as ‘likes’, physical characteristics, educational background, personal summary, etc.

These additional characteristics are commonly known to be the more conventional way of matching couples, based on preferences and commonalities via personality testing and hypothetical questioning. The present invention employs these conventional methods of matching couples together, but simply places a global filter on all results, such that an individual is only matched to other individuals who have a compatible blood type. This ensures that if the couple were to be a successful match, then the potential offspring of the union would not be as subject to the common disorders and issues that can plague babies born with blood that is incompatible with the mother's. It is the intent of the present invention to help prevent birth defects and potential issues encountered when the child's blood is incompatible with the mother's, through the use of selected genetics in the form of the matching of couples' blood-types.

### BRIEF DESCRIPTION OF THE DRAWINGS

FIG. 1 displays the preferred embodiment of the website of the present invention.

FIG. 2 exhibits the preferred embodiment of a standard user's profile page.

FIG. 3 shows the sign-up and profile creation process of the website of the present invention in the form of a flow chart-.

FIG. 4 shows the blood-type matching rules (as donated male to female) that are employed by the system of the present invention.

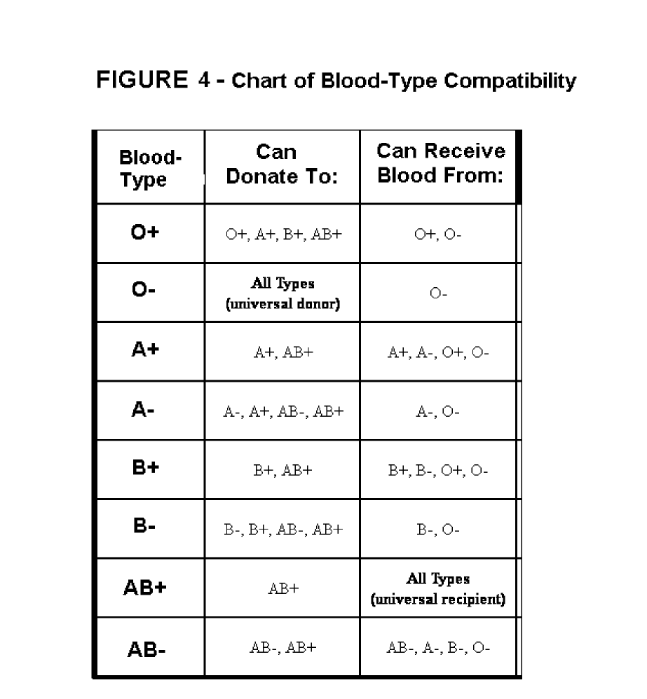

### DETAILED DESCRIPTION OF THE PREFERRED EMBODIMENT

The present invention, an online, website-based couples matching service, preferably hosted by a secured server computer, configured to document and display an array of users personal information, specifically the users' blood-types, as well as other information, to a set of other users of the system with the intent of matching individuals together based primarily on the compatibility of the individuals' blood-types. The system is configured to set the blood-type qualifier for a potential match to be the forefront or premier qualifier used to search for ideal match candidates. In order to utilize the system of the present invention, a visitor must first become a member or user by signing up and providing personal information to create a unique user profile, which includes being prompted to upload a profile picture (380), providing a detailed personal description (360), and select a unique username (370).

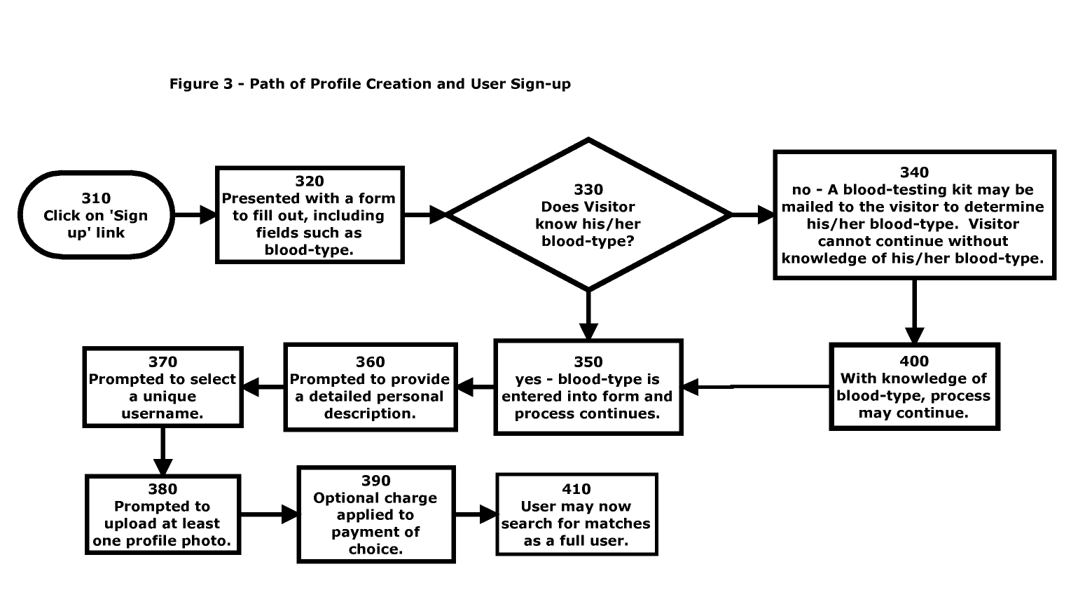

The present invention preferably presents visitors to the website with the direct option to ‘Sign-up’ (60) for the service upon visiting the website for the first time. Visitors may click the signup (60) button in order to create a profile and become an official member and user of the system. However, in order to become a user, visitors must provide basic information about themselves during the profile creation process. The process initiated by clicking the signup (60) button is outlined in FIG. 3. The premier mandatory information required for profile creation is the visitor's blood-type, which is displayed by the blood-type indicator (130) seen on the profiles of all users. In the event that the visitor is not aware of his or her blood-type, the visitor may not become a user until the blood-type has been identified. The website of the preferred embodiment of the present invention provides the visitor with a means of determining his or her blood-type via a third party blood-testing kit. This blood-testing kit may be purchased from the website of the present invention, which will arrive to the visitor's location of choice, preferably via standard mail. It can be envisioned that a fee may be associated with the act of becoming an official member of the website of the present invention. Similarly, it can be envisioned that, if a visitor wishes to become a user, yet must order a blood-testing kit in order to provide an accurate portrayal of the visitor's blood-type; then, the user may be eligible for a discounted rate of membership, given that the blood-testing kit was paid for. Thus, it is contemplated that the cost of the blood-testing kit could offset the cost of a membership, or perhaps entitles the user to a free month of membership of the service of the present invention.

‘Ideal’ matches primarily consist of a set of users of the service of the present invention who maintain a blood-type identically matching that of the user searching for matches. Subsequent search results will include not only identical matches, but all compatible matches as well, namely, those users who share at least one common blood type allele together, namely A, B, or O. This search is preferably built upon the correlation of blood-types as depicted by the blood-type indicator (130) on a user's profile. Advanced searches for matches may also be performed, which go into greater detail based upon an array of search parameters, enhancing the efficacy of the search being performed by the computer. Searches may be quickly entered by the user by simply typing in qualities or search tags into the search field (20) found on any page of the website of the present invention, and clicking the search button (30). Indefinite quantities of tags or search criteria may preferably be entered into the search field (20); however, by default, the system of the present invention will only return individuals with a compatible blood-type. The compatibility of user's blood-types can be seen in FIG. 3. Search tags are only limited by the input of the community of members or users of the present invention as depicted in their custom user profiles. User profile creation is preferably performed by the user upon clicking signup (60) and entails the user elaborating about his or herself, as well as listing preferences and qualities, which may conventionally appear in a search. Additionally, the user will select a unique username (120) upon profile creation. If a user's profile is not completed during the signup process, then the user may later be able to edit his or her profile settings with the Edit Profile (70) button found under the ‘Profile’ (50) menu. It can be envisioned that a user's profile may be linked to other online profiles such as Facebook™ and Twitter™. Profiles may be further enhanced via a series of questions designed to help exhibit the user's online personality, such as conventional online quizzes.

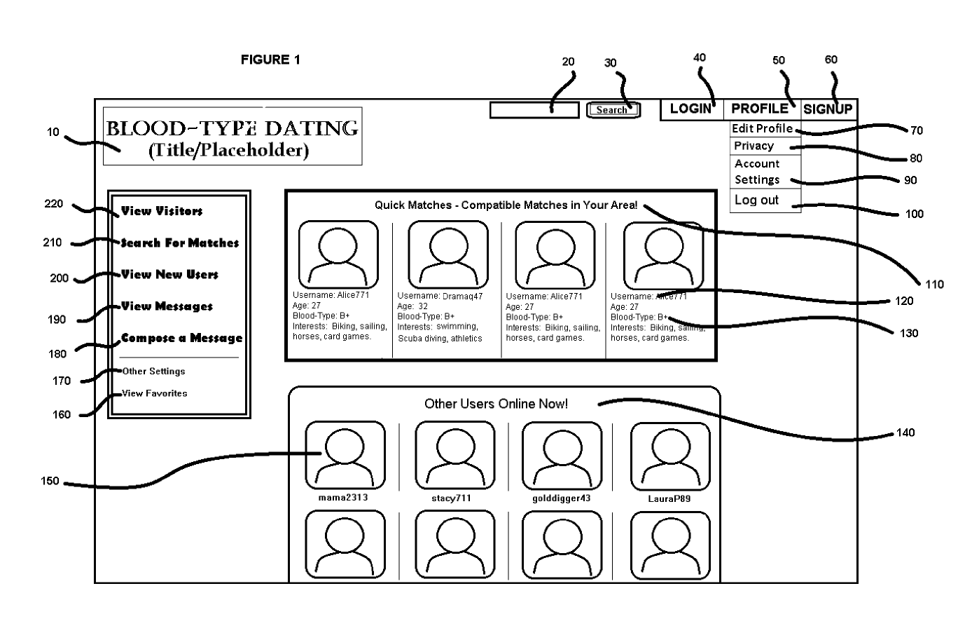

Additionally, the preferred embodiment of the present invention is preferably configured with a robust messaging system designed to facilitate communication between users. It can be envisioned that the present invention maintains both a conventional instant messaging system, as well as a traditional email messaging system integrated into the website of the present invention. In order to communicate directly with another user, a user may select the Compose a Message button (180) preferably found in the left column on the homepage of the website of the present invention, as seen in FIG. 1. Additional messaging options, such as viewing prior messages, deleting messages, archiving messages, and other common options can be accessed via the message center, accessible by clicking on the View Messages button (190) from the home page. The View Messages button (190) brings the user to the message center, which functions similarly to a conventional email client.

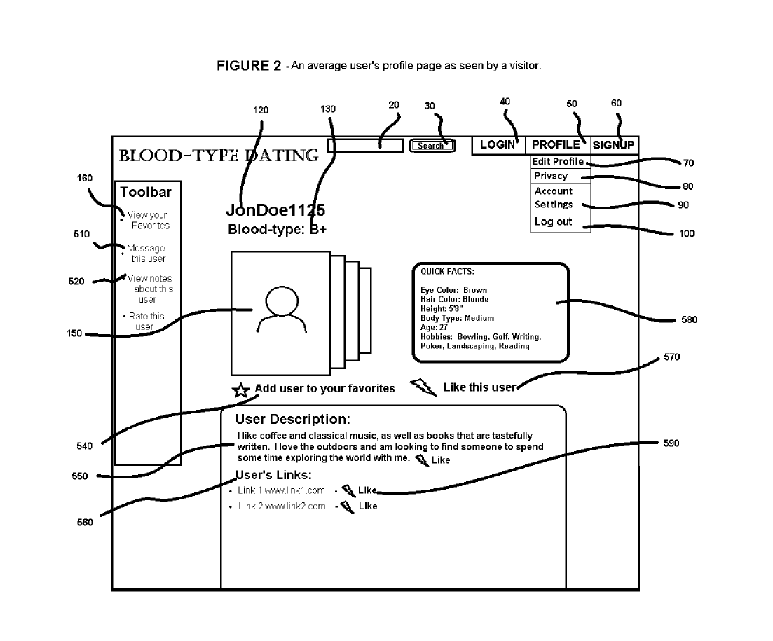

Users also have the capability of viewing the profiles of users who have actively viewed their own profile, thus displaying interest in the individual. Users may easily view the profiles of the individuals that visited their profile by clicking on the View Visitors button (220), preferably found on the left panel of the home page, as seen in FIG. 1. The user is preferably free to send a message any other user, regardless of his or her blood-type. A user may easily message another user while viewing the target user's profile, and clicking the Message This User button (520) preferably found in the toolbar column on the left side of the window, as seen in FIG. 2.

Other useful information can be found while viewing the profile of another user. If the user finds a match that seems appealing and worth additional investigation, he or she may click on the target user's profile picture (150) or username (120), which will cause the computer server to return the specified user's profile page. This specific page is unique for each user, and contains personal information provided by the user, including but not limited to their blood type indicator (130), eye color, body type, height, age, hair color, and hobbies. Many of these can preferably be found in the Quick Facts (580) portion of the user's profile page, as seen in FIG. 2. A detailed description (550) of the user may also be provided which may include a personal summary, additional facts, or preferences. The user viewing another second user's profile may choose to ‘like’ and/or share any links or preferences found as displayed on the second user's profile.

Similarly, it can be envisioned that the website of the present invention could exhibit a conventional comment system, enabling users to comment on user's profiles, posts, shared website hyperlinks (shown as ‘user's links’ (560)), profile picture(s) (150), and other web content provided at the discretion of the user. Comments would preferably be archived by the computer server, and held to be readily accessible by any other user for a pre-determined period of time. Any user's prior comments can be seen by clicking on the ‘View Notes About This User’ link (520) preferably found on the left column of a user's unique profile page. Clicking the ‘View Notes About This User’ link (520) of the present invention will return all comments and their corresponding links, posts, or other content within the reach of the comment system. Additionally, users could decide to ‘like’ other user's links (590), and share them to other social networks, providing full social network integration to the website of the present invention. As an expansion to the concept, it is similarly contemplated that user's could choose to select a preferred user and designate him or her a ‘favorite’ by pressing the ‘Add to Your Favorites’ button (540) as seen in FIG. 2. Favorites selected by the user of the website and service of the present invention may be viewed at any time by clicking on the View Favorites button (160). The ‘favorites’ designation is instrumental at times when a user wishes to attempt to contact another user as a potential match, but simply wished to wait until adequate time was available to construct a meditated message as a first contact. The concept of ‘favorites’ is known to be conventional with respect to websites, such as a user profile, that is desired to return to later.

Alternate embodiments of the present invention could include a subsidiary service preferably designed to send periodic automated emails to all users featuring users that the system deems as matches in accordance with a set of protocols, executed on the secured server of the present invention, fashioned to compare users based on their blood-type compatibility first, and their profile descriptions and preferences second. Within the emails, users will be presented with a number of these potential matches, along with their corresponding profile photos (150), at which time they may choose to directly message the potential match, favorite the user's profile to return to later, or simply delete the email.

Another embodiment of the present invention could feature additional methods of connecting two users who are unfamiliar with each other's profiles. For example: on the website of the present invention, users could elect to participate in a form of speed matching, which could be similar to ‘speed dating’ in the physical world. Compatible users would be selected at random, and would appear in a private chat room at the will of the user, so that the two strangers could have the chance to meet immediately. It can be envisioned that web cameras could be employed to facilitate face-to-face communication during the chat sessions. At any time, either user has the option to end the conversation and move on to meet with another random user who maintains a compatible blood-type. It is contemplated that these users electing to meet via ‘speed matching’ could thereby manage to meet a maximum number of compatible users in a short amount of time, increasing the likelihood that an acceptable match is found.

An additional embodiment of the present invention could feature a community calendar element which would present a series of events that could facilitate the meetings of users in the physical world. These meet-ups could be based on blood-type, so that all attending users would not necessarily feel self-conscious of their blood-type while meeting other users as potential mates. These calendar events could be specifically sponsored by the service of the present invention, and would preferably feature ice-breaker activities designed to help participants get to know each other swiftly, in a broad or general manner.

It is similarly contemplated that a form of verification process could be implemented in the event that a visitor does not require the third-party blood-testing kit provided for a preferably nominal fee. If the kit is not purchased, then the visitor has knowledge of his or her blood-type from an outside source, such as a blood clinic or blood donation site. However, it can be envisioned that the visitor may not become a full user without verifying his or her blood type with a scan or fax of the physical paperwork from an external source such as a clinic, indicating the individual's blood-type. This form may be presented in the form of an image on the user's profile on the website of the present invention, to provide proof of his or her blood type.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

I claim:

1. A system for connecting people based on compatible blood types comprising:
a secured server computer connected to a network;
a blood type testing kit;
a web-based application; and
a database, said database connected to said network and said web-based application.

2. The system of claim 1, wherein said secured server computer hosts said web-based application.

3. The system of claim 1, wherein said blood type testing kit is required to create a user profile for a user.

4. The system of claim 1, wherein said database groups people according to their blood type established via said blood type testing kit.

5. The system of claim 4, wherein said web-based application displays compatible individuals to the user according to established blood types.

6. A method for connecting a person to a group of people based on compatible blood types comprising:
a secured server computer hosting a web-application and an online database;
the secured server computer creating a user profile for the person based on data provided by the first person;
the secured server computer storing the data in the online database;
the secured server computer asking the person to confirm his blood type via a blood type test;
the secured server computer updating the data of the person to include his blood type; and
the web-based application matching the person to the group of people when the established blood type of the first person is compatible with the established blood type of the second person.

7. The system of claim 5, wherein the web-based application has a direct messaging client.

8. The system of claim 5, wherein the blood type is confirmed by a third party.

9. A method for connecting a user to a group of users comprising:
a computer providing access to the user to a web-based application;
the computer establishing a profile for the user on the web-based application;
the web-based application requesting that the user supply a blood type via a blood type test;
the computer logging the blood type of the user into a database;
the database matching the user to the group of users based on compatible blood types; and
the web-based application displaying the resulting group of users based on compatible blood types to the user.

10. The method of claim 9, wherein the user may message the resulting group of users via a messaging client within the web-based application.

11. The method of claim 9, wherein users with incompatible blood types are not displayed to the user.
